(19) United States
(12) Patent Application Publication
(10) Pub. No.: US 2009/0275404 A1
(43) Pub. Date: Nov. 5, 2009

(54) PLAYER TERMINAL ACCESSING SELECTABLE GAMES

(75) Inventor: Stanley Kromydas, Las Vegas, NV (US)

Correspondence Address: Virtual Legal, LLC, P.O. Box 22028, Carson City, NV, 89721, US

(73) Assignee: Bally Technologies, Inc.

(21) Appl. No.: 12/113,043

(22) Filed: Apr. 30, 2008

(51) Int. Cl. A63F 13/00

(52) U.S. Cl. 463/29

(57) ABSTRACT

A gaming method and system that enables at least one player terminal to access a plurality of selectable games is described. The method comprises networking gaming modules, in which each gaming module is configured to control a selectable game. Additionally, each gaming module is coupled to a player terminal with a plurality of user controls. The method enables the user controls associated with a single player terminal to access a plurality of selectable games. The method then proceeds to receive a user instruction from the single player terminal that selects at least one networked gaming module. A result is generated that determines whether a prize is awarded for each selectable game. The result for each selectable game is displayed on a publicly viewable display that is operatively coupled to the selected networked gaming module.

### FIELD OF THE INVENTION

The invention relates to a method and system that enables a player terminal to access a plurality of selectable games. Additionally, the system and method present the results for the selectable games on a publicly viewable display.

### BACKGROUND

Gaming machines such as slot machines include a primary game and a bonus game. The game is begun when a coin, credit, coupon, cash or other financial instrument is input into the gaming machine. A player is then given an opportunity to place a wager, and the wager selection process can be relatively complicated depending on the type of game. For example, the player has to select the amount to wager, the number of paylines to play, and possibly even evaluate a paytable. The player then proceeds to “pull” the slot handle by pushing a button that initiates game play for the primary game.

During the primary game play, the reels spin and a player waits for the outcome of the game session. During primary game play, the underlying game accesses a random number generator (RNG) that generates a random output. The random output is then used to determine whether a player is awarded a prize.

There are a variety of different awards that a player may win in the base game such as credits, a progressive, or the ability to play a bonus game. The player is awarded a prize based on the paytable and the random number. For those games offering a progressive jackpot win event, a portion of the players' wagers are placed in a “pot” and each player has an opportunity to win the progressive jackpot by making a specially designated wager.

Another prize may also be awarded after playing a “bonus” game. The bonus game is a secondary game. A subset of secondary games is called a game-within-a-game, which is often used to refer to a secondary game that uses some elements from the primary game. An example of a secondary game on a reel machine that may also be called a game-within-a-game is a secondary game that uses a subset of the reels used by a primary game. A bonus or secondary game is triggered by the occurrence of a primary game event. A winning game outcome in the bonus game may result in awarding a bonus prize that is added to the prize won in the underlying primary game. Alternatively, a winning game outcome in the bonus game may result in multiplying the prize in the underlying primary game. A more detailed discussion of a bonus game feature is provided in commonly assigned U.S. Pat. No. 7,351,144 entitled BONUS GAME USING A SUBSET OF REELS that is hereby incorporated by reference.

Generally, class III type gaming machines support two types of gaming architectures. In the traditional gaming architecture, the gaming engine is in a self-contained gaming machine. In the remote-display gaming architecture, the gaming machine on the illustrative slot floor operates like a terminal with a graphics engine, the game is run on a backend server, and the results are displayed on the terminal having the graphics engine.

### SUMMARY

A gaming method that enables at least one player terminal to access a plurality of selectable games is described. The method comprises networking gaming modules, in which each gaming module is configured to control a selectable game. Additionally, each gaming module is coupled to a player terminal with a plurality of user controls. The method enables the user controls associated with a single player terminal to access a plurality of selectable games. The method then proceeds to receive a user instruction from the single player terminal that selects at least one networked gaming module. A result is generated that determines whether a prize is awarded for each selectable game. The result for each selectable game is displayed on a publicly viewable display that is operatively coupled to the selected networked gaming module.

Additionally, a gaming system that enables a player terminal to access a plurality of selectable games is described. The gaming system comprises a plurality of networked gaming modules, a plurality of player terminals, and a publicly viewable display. The networked gaming modules are each configured to control a selectable game. Each of the player terminals include a plurality of user controls and each player terminal is communicatively coupled to each networked gaming module. A single player terminal has user controls that can access a plurality of selectable games. A user instruction is received from the single player terminal and selects at least one networked gaming module. The networked gaming module generates a result that determines whether a prize is awarded for each selectable game. The publicly viewable display is operatively coupled to the selected networked gaming module and the publicly viewable display shows the results of each selectable game controlled by the associated player terminal.

Furthermore, a player terminal configured to access a plurality of selectable games is described. The player terminal is configured to be communicatively coupled to each networked gaming module. The player terminal has a plurality of user controls that are configured to access a plurality of selectable games. The user instruction that is received from the player terminal selects at least one networked gaming module. Each networked gaming module is configured to control a selectable game and to generate a result that determines whether a prize is awarded for each selectable game. The networked gaming module is operatively coupled to a publicly viewable display that shows the results of each selectable game controlled by the player terminal.

### DRAWINGS

The present invention will be more fully understood by reference to the following drawings which are for illustrative, not limiting, purposes.

FIG. 1 shows an illustrative player terminal and illustrative publicly viewable displays.

FIG. 2 shows an illustrative gaming system in a ring network configuration that enables a player terminal to access a plurality of selectable games.

FIG. 3 shows an illustrative gaming system using a local area network configuration that enables a player terminal to access the plurality of selectable games.

FIG. 4 shows a block diagram of an illustrative player terminal.

FIG. 5A shows the illustrative player terminal embedded in a chair.

FIG. 5B shows illustrative screen shots for the player terminal.

FIG. 6 shows an illustrative system configuration for the tournament game embodiment.

FIG. 7 shows an illustrative flowchart of a method for supporting a group of networked player terminals that access the plurality of selectable games.

### DETAILED DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the devices described hereinafter may vary as to configuration and as to details. Additionally, the methods may vary as to details, order of the actions, or other variations without departing from the illustrative method disclosed herein.

The systems and methods described herein enable a player terminal to access a plurality of separately selectable games and display the results for each selectable game on a publicly viewable display. Additionally, the systems and methods described herein allow the player to play more than one game at a time from the same player terminal. The player terminal may be embedded within a chair, integrated into a bar top, or into a slot bank. The player terminal enables a player to view all the selectable games that are active and the game results on a publicly viewable display.

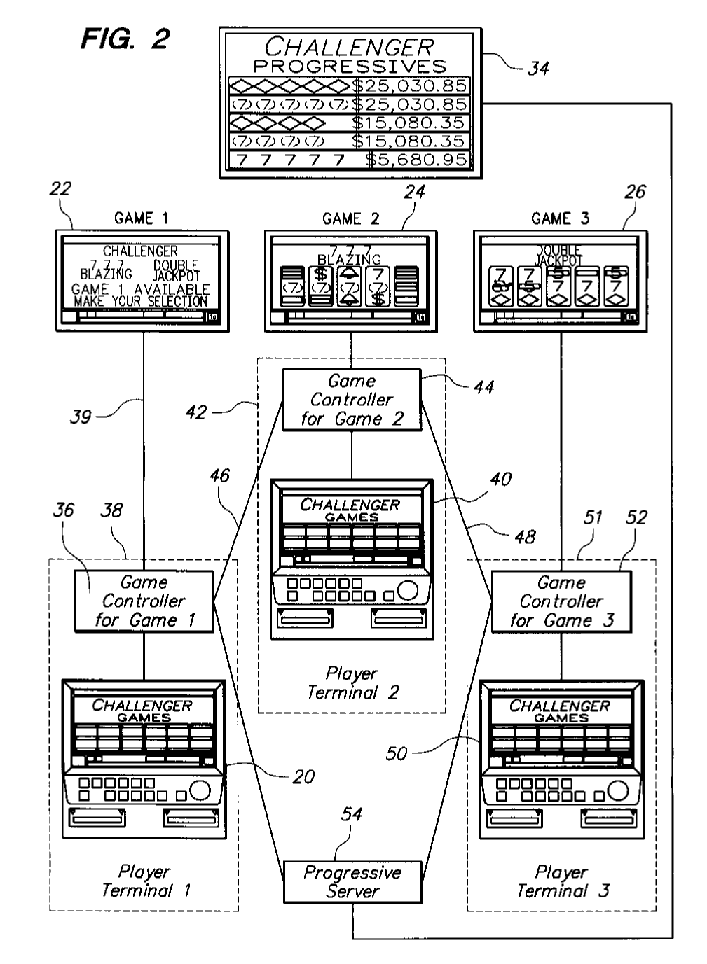

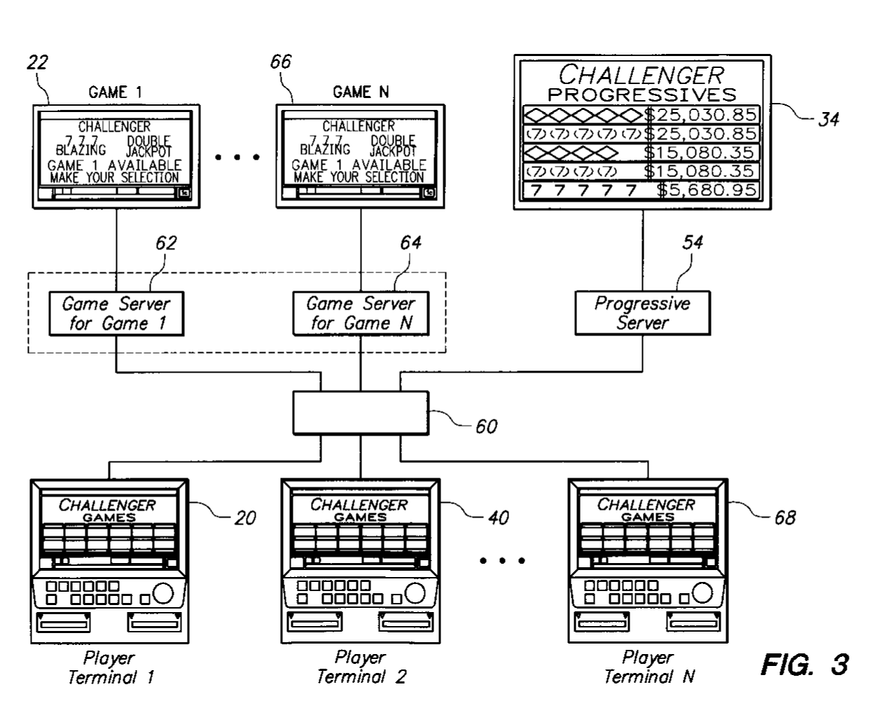

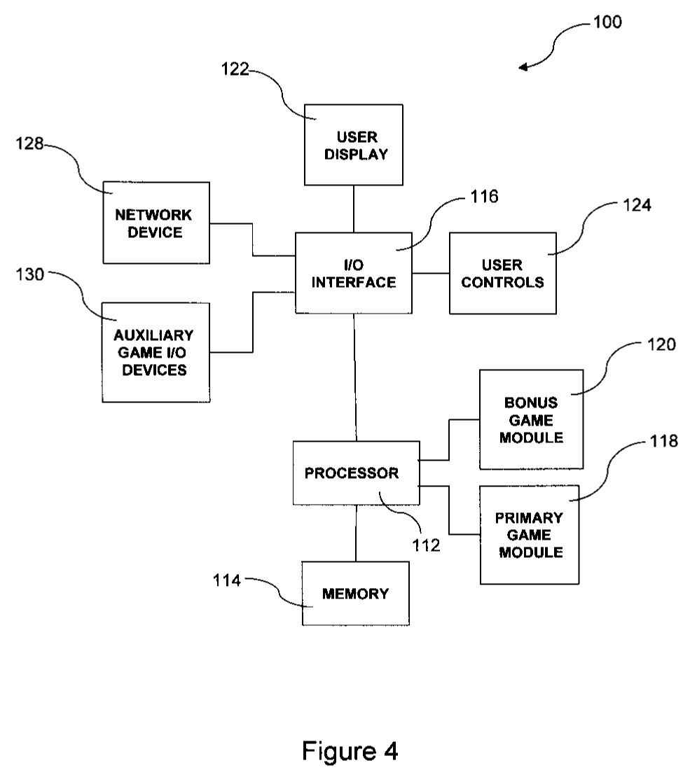

The gaming system comprises a plurality of networked gaming modules that may be embodied as a game controller (in FIG. 2), a game server (in FIG. 3), a game module (in FIG. 4) or any combination thereof. The player terminal's user controls are adapted to control and trigger the operation of the networked gaming modules, and as a result the player terminal varies between being a thick client, thin client, or pseudo stand-alone client.

In the illustrative embodiments described herein, the networked gaming modules are each configured to control a selectable game. Additionally, each player terminal includes a plurality of user controls that communicate user-defined player instructions to each networked gaming module. Thus, a single player terminal has user controls that can access a plurality of selectable games. In operation, the networked gaming module generates a result that determines whether a prize is awarded for each selectable game. The publicly viewable display shows the results of each selectable game controlled by the associated player terminal.

In the illustrative embodiments the player terminals are adjacent to one another or in close proximity to one another. The proximity of player terminals enhances the competitive game play environment because players can “challenge” one another to obtain the largest winning prize. Additionally, the publicly viewable displays provide greater exposure to passing potential players because the display showing the game results are in one location or along a particular wall area. Furthermore, the systems and methods described enable players to compete in a “tournament” mode, where players compete with one another for a fixed period of time.

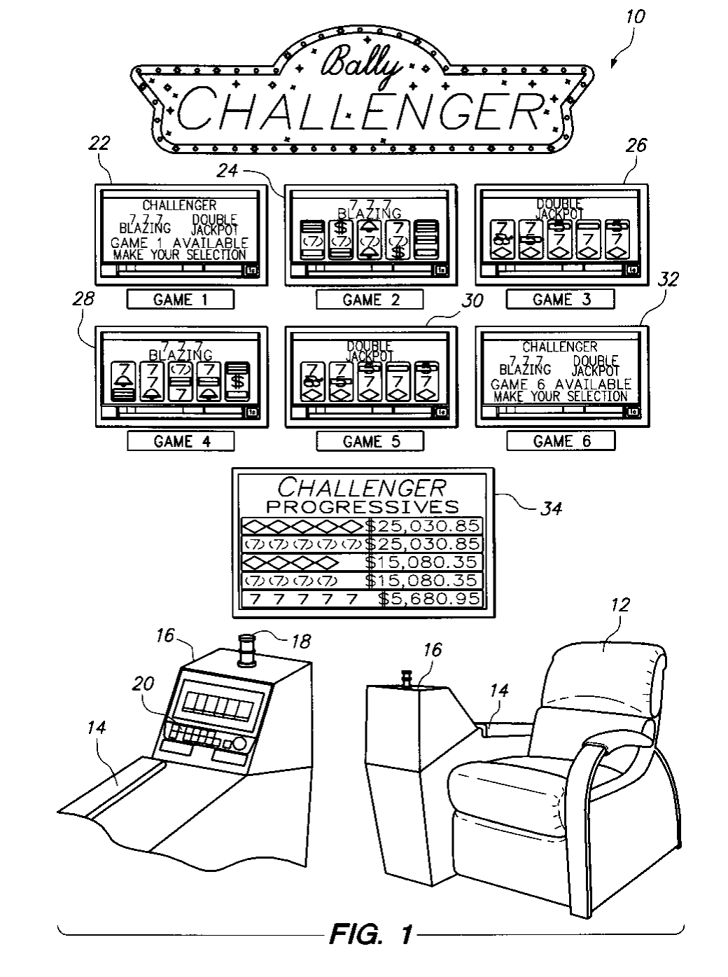

Referring to FIG. 1 there is shown a system 10 that includes a player terminal and publicly viewable displays. The illustrative player terminal 16 is fixedly coupled to a chair 12 having armrests 14, where one of the armrests 14 has the embedded player terminal 16. A back view and front view of the player terminal 16 are presented. The front view of the player terminal 16 includes a raised beacon lighting element 18 that may indicate a bonus has been awarded, and user control panel 20 that may also be referred to as a “dashboard.”

The player terminal 16 is configured to access a plurality of selectable games that are each associated with a networked gaming module. The illustrative user control panel 20 provides user controls that enable a player to access the selectable games.

The results for the user selectable games are presented on publicly viewable displays. In the illustrative system 10, six publicly viewable displays 22, 24, 26, 28, 30 and 32 that are each associated with a selectable game that is picked by the player terminal 16. Additionally, a progressive display 34 is also shown indicating different prizes for different progressive combinations. Generally, the players must look up to see the publicly viewable displays.

By way of example and not of limitation, the displays 22 through 32 are large displays that have relatively large flat-panel screens such as a 40-inch screen size for the selectable games and a 60-inch screen size for the progressive display 34. The flat-panel screen may be an LCD flat-panel display or plasma flat-panel display.

Referring now to FIG. 2 and FIG. 3, there are shown two illustrative embodiments with networked gaming modules. In FIG. 2, the networked gaming modules are self-contained in the player terminal and are networked in a daisy chain or ring network arrangement. In FIG. 3, a local area network communicatively couples the user controls of the player terminals to the game servers via a shared hub; the selectable games run on a corresponding game server and the results are displayed on the corresponding display. Thus, in FIG. 2 the networked gaming module is housed within the self-contained player terminal, and in FIG. 3 the networked gaming module is run on a backend server and the player terminal simply provides the user controls.

Regardless of the particular networked gaming module embodiment, a user instruction is received by the player terminal that selects at least one networked gaming module configured to run a user selectable game. Each networked gaming module is configured to control a selectable game and to generate a result that determines whether a prize is awarded for the particular selectable game. Additionally, each networked gaming module is operatively coupled to a publicly viewable display that shows the results of each selectable game controlled by the player terminal.

Referring to FIG. 2 there is shown an illustrative gaming system 35 in a ring network configuration that enables a plurality of self-contained player terminals to access a plurality of selectable games. The illustrative networked gaming modules are self-contained in the player terminals and are networked together. The first terminal 16 includes user controls 20 and a game controller 36 that displays the game results in display 22. In the illustrative embodiment, the user controls 20 include user selectable buttons 21a and a display 21b that enables a user to select one of the user selectable games.

The second player terminal 42 also includes a separate set of user controls 40 and a second game controller 44 that is communicatively coupled to game controller 36 with networking cable 46. The results for the second game controller 44 are displayed on publicly viewed display 24. Additionally, the illustrative gaming system 35 includes a third player terminal 51 that comprises user controls 50 and a third game controller 52. The results for the third game controller 52 are shown on display 26. The second game controller 44 is communicatively coupled to the third game controller 52 with cable 48. Additionally, a progressive server 54 is also communicatively coupled to the networked gaming modules 36 and 52. Display 34 shows the progressive server 54 results.

By way of example and not of limitation, a user instruction is input into user controls 20 of player terminal 16 and another networked gaming module such as game controller 44 is selected. The game controller 44 is configured to control selectable game 2 and generates a result that is displayed on publicly viewable display 24. Thus, in this illustrative embodiment, a self-contained player terminal is able to access a separate game controller corresponding to a separate player terminal and view the result on the publicly viewable display.

Referring to FIG. 3 there is shown an illustrative gaming system using a local area network configuration 58 to enable each player terminal to access the plurality of game servers. The system comprises a plurality of local servers 62, 64 and progressive server 54 that are each communicatively coupled to player terminals 20, 40 and 68 via a local network having a hub 60. The game servers 62, 64 and progressive server 54 may be any serviceable type, running the server software constructed to implement the functions described herein, and may include but are not limited to IBM 4000 or 6000 series, Microsoft Servers, Linux servers, etc. Typically the network connections will be implemented using standard Ethernet LAN networking technology, but any electronic or wireless network technology may be used. The application software embodying the functional aspects of the system described herein will communicate with the player terminals using the same underlying protocols as are currently in use for player card systems, gaming machine monitoring and reporting, etc.

The results from each server 62, 64, and 54 are viewable on displays 22, 66 and 34, respectively. Thus the game servers 62 and 64 each run a selectable game that can be accessed by any one of the player terminals 20, 40 and 68. The results presented on displays 22, 66, and 34 are associated with servers 62, 64 and 54, respectively. The local area network 58 supports a cluster of player terminals, multiplayer bank, or bar top arrangement of player terminals 20, 40 and 68. The total number of player terminals varies; however, the player terminals are typically near one another.

The servers typically have installed software that enables a player terminal to access selectable games that are processed by the corresponding server. If the player terminals are traditional class III gaming machines, where the game logic as well as presentation/graphics and other logic all reside on each machine, the servers primarily enable the separate player terminals to access the server's selectable games. In general, if the player terminals are class III gaming machines with separated game logic, a game engine associated with each player terminals may reside on one or more of the servers.

Referring now to FIG. 4 there is shown an illustrative player terminal that may also be referred to as an electronic gaming machine (EGM). The player terminal 100 has many embodiments including the components and features typically found in a personal computer. Illustrative player terminal 100 includes a processing element 112 that is operatively coupled to a memory element 114, and an input/output (I/O) interface element 116. Player terminal may also include a primary game module 118 and a secondary or bonus game module 120.

Memory 114 and processor 112 are capable of storing and executing primary game module 118 and bonus game module 120. Processor 112 may be any conventional logic processing device, such as a central processing unit, digital signal processor or application-specific integrated circuit (IC). Memory 114 generally includes random access memory (RAM) and read only memory (ROM) components.

Primary game module 118 includes computer programming configured for carrying out operations associated with primary games, such as slot machine, poker, “black jack”, keno, video lottery, mahjong, or like popular games. Bonus game module 120 includes computer programming configured for carrying out operations associated with a bonus game feature. Bonus game operations include, for example, monitoring eligibility or qualification of player terminal 100 for bonus play, enrollment of player terminal 100 in a bonus play game if the player terminal 100 is eligible, displaying whether or not player terminal 100 is eligible for bonus play and what steps, if any, are needed to achieve eligibility, monitoring and displaying occurrence of triggering events, offering bonus prizes to player terminal 100, monitoring acceptance or rejection of bonus prizes by player terminal 100, and displaying acceptance or rejection of bonus prizes by other player terminals or groups of player terminals.

Input/output (I/O) interface 116 is operatively coupled to a user display 122, user controls 124, a network device 128, and auxiliary game I/O devices 130. I/O interface 116 allows communication between processor 112 and the various I/O devices 122, 124, 128, 130 and thus allows a player using player terminal 100 to interact with and play primary and bonus games 118, 120 by providing input control signals and receiving output control signals associated with operation of games 118, 120.

User display 122 may comprise a video display such as a cathode ray tube (CRT), a liquid crystal display (LCD) panel, or like display device capable of providing visual output to a user or player of player terminal 100. User controls 124 may comprise input buttons, switches, levers, keypad, touch-pad, touch screen controls, or other devices that allow a user to input signals regarding game play features, wager amount, wager execution, acceptance or rejection of a bonus prize, or other signals from the user.

Network device 128 comprises a communication device such as a network card or serial device for communicating with other network devices (e.g., back-end servers) via a network which is operatively coupled to the network device 128. Network device 128 allows player terminal 100 to be interfaced to the systems and methods described herein. Network device 128 also allows interface of player terminal 100 with other gaming and casino servers for carrying out security, authorization, authentication, and other gaming and casino operations.

Auxiliary game I/O devices 130 may also be included with player terminal 100, such as speakers, lights, alarms, buzzers, LED display, MIDI or MP3 player devices capable of playing fanfare music or other sounds, and the like. I/O devices 130 may be used to indicate events related to bonus play, such as occurrence of triggering events, and offers and acceptance of bonus prizes by player terminal 100 or other player terminals. I/O devices 130 may also indicate events associated with primary game play.

In operation, the systems described above in FIG. 2, FIG. 3, and FIG. 4 enable a player to interact with a non-tournament “Challenger” embodiment or a tournament embodiment. In a non-tournament embodiment, the player terminal is provided with access to a plurality of selectable games that each operate on a separate gaming controller or gaming server. Each game server has a corresponding display that shows the results that indicate whether a prize has been awarded to the player. In the illustrative embodiment, the player terminal can select to play up to one half of the total quantity of gaming modules with the single player terminal. Additionally, the networked gaming modules embodied as game controllers, game servers, or game modules are communicatively coupled to a progressive server that is operatively coupled to a progressive display.

In the “Tournament” embodiment, each player terminal is associated with a single server having a single selectable game. In the tournament mode, a set time period identifies the period during which each player terminal is associated with the single selectable game.

The illustrative embodiments that enable a player terminal to access a plurality of selectable games include, but are not limited to, the networking of standalone class III gaming machines, the networking of class III gaming machines where the display portion and the gaming engine portion of each logical machine do not physically reside on the same physical machine, and the networking of class II gaming machines.

The illustrative embodiment described herein could also be implemented in software using a multiplayer protocol. For example, it shall be appreciated that the illustrative system described herein may be implemented with software downloads using the download and configuration server system and slot management system described in patent publication 2008/0064501 entitled DOWNLOAD AND CONFIGURATION CAPABLE GAMING MACHINE OPERATING SYSTEM, GAMING MACHINE AND METHOD, currently commonly owned and hereby incorporated in full, by reference.

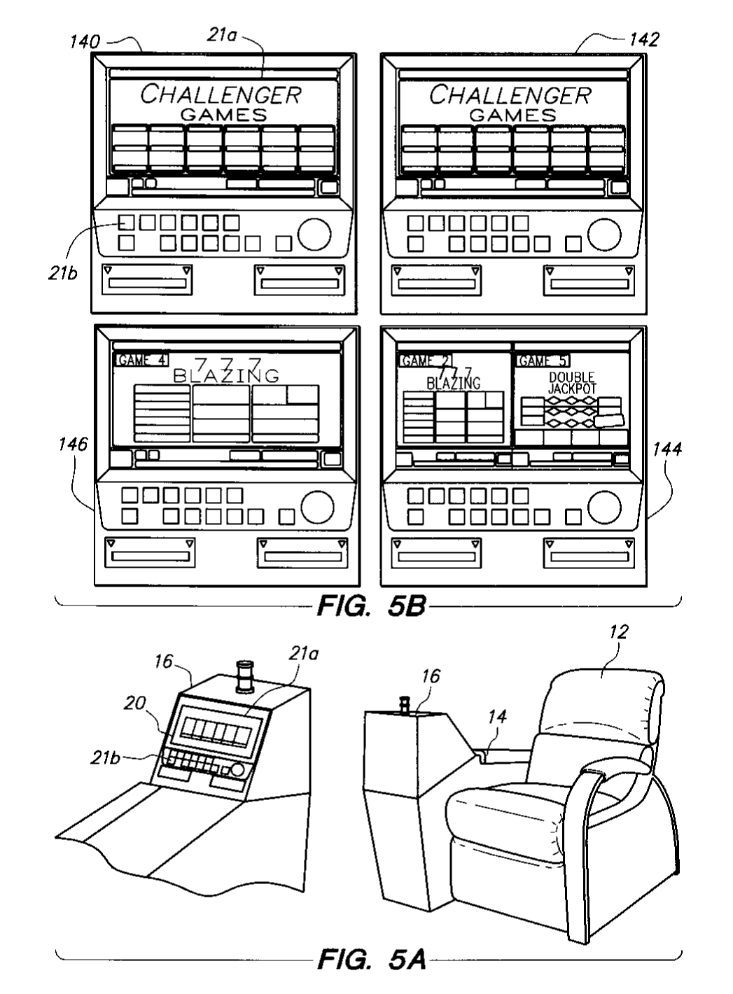

Referring to FIG. 5A there is shown the illustrative player terminal embedded as described in FIG. 1. The chair 12 includes an armrest 14 with an embedded player terminal 16. The front view of the player terminal 16 shows a user control panel 20 that includes user selectable buttons 21b and a proximal display 21a (shown in FIG. 2) that enables a player to select one of the user selectable games.

In FIG. 5B there is shown a plurality of screenshots for the proximal display 21b. In the first screenshot 140, there are six different games that can be selected from player terminal 16. The six different games can be viewed from display 21a. The illustrative primary games include Blazing 777 and Black and White. In the illustrative embodiment, the display 21a is a touch-screen display and the illustrative player can select one or more games to plays. More particularly, up to one-half of the total number games, i.e. three games, may be selected for game play. The user controls 21b include a variety of buttons such as a spin reel button, cash out button, play credit buttons, and play line buttons.

The screenshot 142 presents a screen where only two out of the six games are open, namely, game 1 and game 6. The remaining games 2, game 3, game 4 and game 5 have been occupied and are not available to the player interacting with player terminal 16.

The next screenshot 144 presents the paytable views for two games. The paytable for Game 2, i.e. Blazing 777, is shown on the left hand side of screenshot 144. Additionally, the paytable for Game 5, i.e. Black & White Double Jackpot, is presented on the right hand side of the screenshot. Screenshot 146 presents a single paytable for Game 4, i.e. Blazing 777.

The game themes shown on proximal display 21a may vary and include slot games, poker or a combination of games previously described. The game themes may also be selectable and the display 21a may also present help screens. In an alternative embodiment, the display 21a may also be configured as a bar top game. Generally, the small proximal display does not show the results and the large publicly viewable screen would display the primary game results, bonus game results, progressive results, and player information.

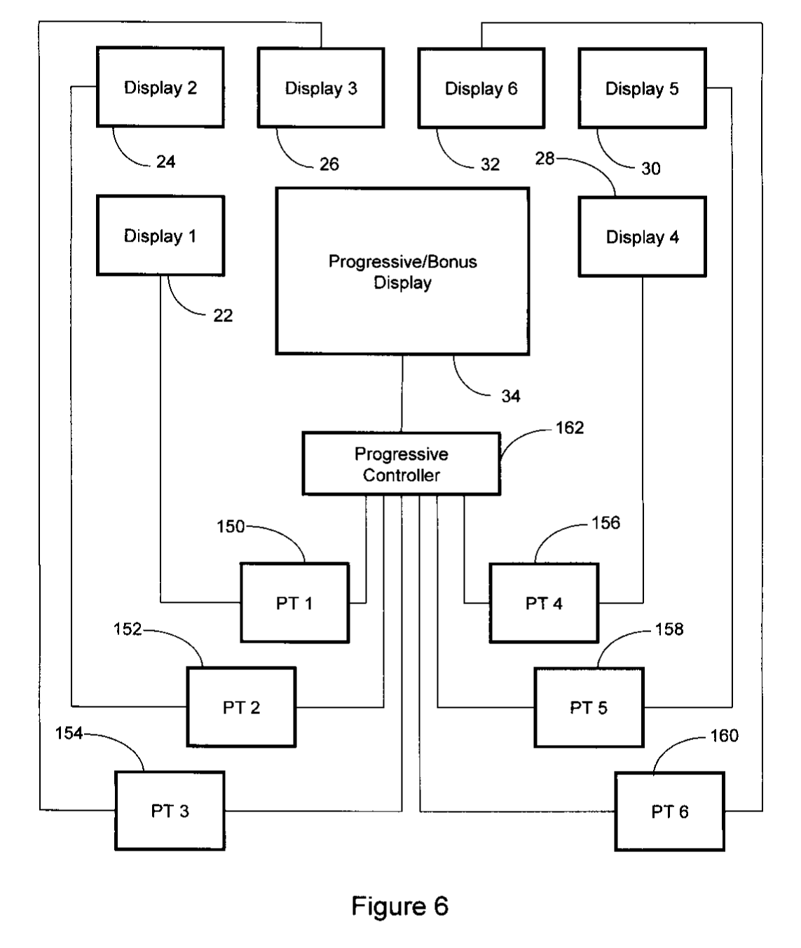

Referring to FIG. 6 there is shown an illustrative system configuration for the tournament game embodiment. The tournament embodiment operates in a manner similar to the embodiments described above, except the goal is to have a group of players competing against one another for a fixed period of time. In general, the tournament embodiments include, but are not limited to, having players in a local geographic region such as a slot bank compete against one another for a set time period and having the large screens display the game results. The objective is to create a competitive gaming environment where the results are presented on a large wall area of the casino floor or even displayed on the entire casino floor.

In operation, the players sit down to play and a countdown timer is triggered when the tournament begins. The results during the tournament are presented on the publicly viewable displays. In the illustrative embodiment shown in FIG. 6, there are six player terminals 150, 152, 154, 156, 158, and 160 that are operatively coupled to publicly viewable displays 22, 24, 26, 28, 30 and 32, respectively. Additionally, the six player terminals 150, 152, 154, 156, 158 and 160 are communicatively coupled to progressive controller 162. The progressive controller 162 is operatively coupled to large display 34 and presents bonus prizes, progressive prizes, or any combination thereof. Illustrative display 34 is larger than the publicly viewable displays 22, 24, 26, 28, 30 and 32. The large display is configured to show the results of a bonus round, bonus amounts, and displays the progressive meters as shown in FIG. 1 through FIG. 3.

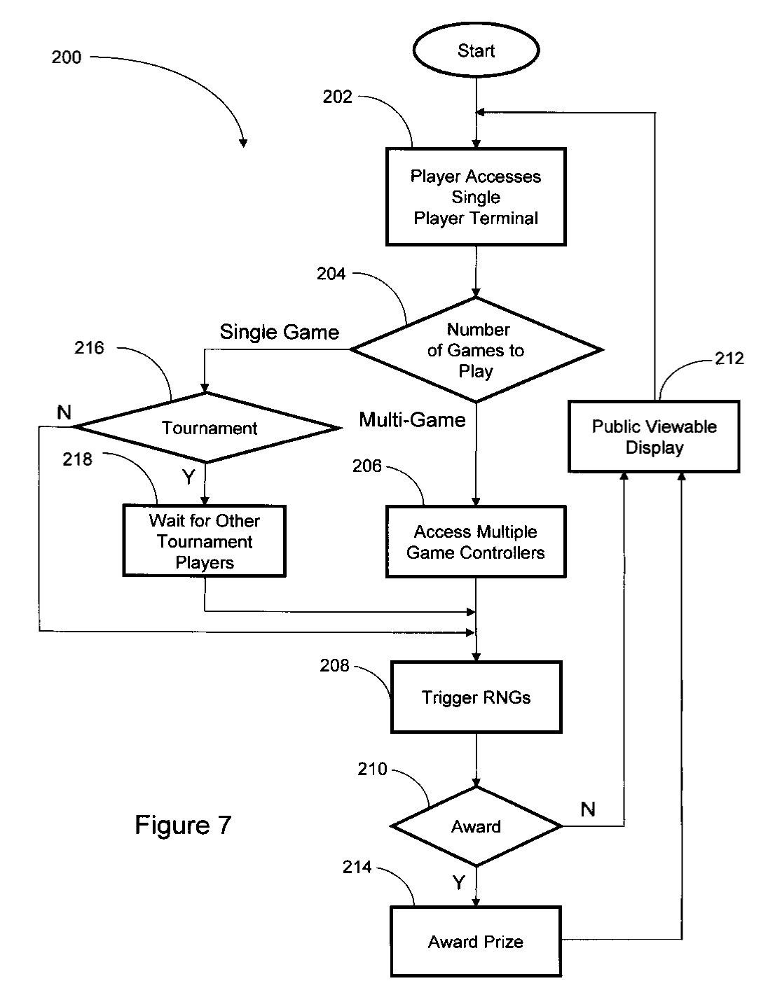

Referring to FIG. 7 there is shown an illustrative flowchart of a method for supporting a group of networked player terminals that are each enabled to access the plurality of selectable games. The gaming systems and player terminal described herein enable the individual player to play one or more different games from a single player terminal.

The method 200 is initiated at block 202 where the player is seated at a player terminal that is shaped like an oversize chair with large armrests, in which the user controls are built into one of the arms of the oversize chair as described above. Alternatively, the player terminals may be located in a bar top or a slot bank and the publicly viewable display would be on the back bar or on a casino wall, respectively. The illustrative player then proceeds to obtain credits that are wagered at the single player terminal.

The single player terminal is configured to be communicatively coupled to a plurality of networked gaming modules as described above. Each of the networked gaming modules is configured to control a selectable game as described above. The player terminal has a plurality of user controls that are configured to access the selectable game associated with the corresponding networked gaming module.

At the beginning of the game session, the player initiates a normal game playing state and the player selects the game to play, the number of paylines to play, analyzes a paytable, or any other such activity associated with a normal game playing state for a primary game. The illustrative player terminal includes stand-alone game features such as player tracking, bill acceptor/ticket printer, and other such stand-alone game features. An illustrative view of the display corresponding to the player terminal is presented above in FIG. 5B, where six different games are presented in screen shot 140, and all the game information and user control are provided at the player terminal.

The method then proceeds to decision diamond 204 where the player selects the number of games to play from the single player terminal. In operation, the user controls associated with the single player terminal accesses the plurality of selectable games that each correspond to a particular gaming module. The single player terminal then proceeds to receive the user instruction from a player that selects at least one networked gaming module.

If the player elects to play a plurality of games from the single player terminal at decision diamond 204, then the method continues to block 206 where the player selects 2 or possibly 3 games when 6 games are available. Thus, the user instruction that is received enables the player to access a plurality of selectable games from a single player terminal. In the illustrative embodiment, a single player can play up to half the total games. The determination of the total games is determined by the number of player terminals and their corresponding large publicly viewable displays. Thus, a total quantity of gaming modules is identified and the single player terminal is associated with up to one half of the total quantity of gaming modules.

The method then proceeds to block 208 where a random number generator (RNG) is engaged and the RNG output is compared to a paytable, thereby determining whether the player is awarded a prize for that particular game session.

At decisions diamond 210, a result is generated that determines whether a prize is awarded for each selectable game. The type of prize varies and may include a primary game, a bonus game, a progressive game, or any combination thereof. For an illustrative progressive game, a progressive server is communicatively coupled to the plurality of gaming modules. In the illustrative embodiment, the progressive server is also operatively coupled to a progressive display that is publicly viewable as described above.

If no prize is awarded, the method proceeds to block 212 where the results are viewed on the overhead wall of large screens which would have a game number or station number to see the game play. As previously described, the publicly viewable display is operatively coupled to the selected networking module. The illustrative large screen presents the game session results such as reels spinning or a poker hand being played. If the player is awarded a prize at decision diamond 210, the method proceeds to block 214 where the player is awarded a prize and the prize is displayed on the publicly viewable display of block 212. An illustrative player's view of the wall display is described above. In operation, the games would play as fast as the player wanted and would have a certain time limit if the player was playing one or more than one game after the last coin was played before the game would be available to other players.

Returning to decision diamond 204 where the election to play a single selectable game has been made, and the method proceeds to decision 216. The basis for single selectable game election may be made by the player, or when all the player terminals are filled and a single player cannot access the multi-game embodiment, or when the players have elected to enter the tournament mode. Thus, the player terminals access the gaming modules to enable the single player terminal to be associated with a single selectable game.

The method then proceeds to decision diamond 216 where the player decides to play a “tournament” game. In the tournament game embodiment, the player is playing against a larger amount of people that may include ten (10) or up to twenty (20) separate players that are accessing different player terminals. During tournament game play, the group of players at the players terminal would have the ability to select the game they would like to play such as “Blazing 7777” or “Black and White,” as an example. Additionally, players may have to wait for other players to join the tournament game as indicated by block 218. In the illustrative embodiment, the tournament game could be played as a timed event between individuals and a number of players. Bonus games may also be based on a timed event. The method then proceeds to block 208 as described above.

In summary, the gaming systems and methods described herein are configured to enable at least one player terminal to access a plurality of selectable games. It is to be understood that the detailed description of illustrative embodiments are provided for illustrative purposes. The scope of the claims is not limited to these specific embodiments or examples. Various structural limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A gaming method that enables at least one player terminal to access a plurality of selectable games, the method comprising:
networking a plurality of gaming modules, wherein each gaming module is configured to control a selectable game, and each gaming module is operatively coupled to a player terminal with a plurality of user controls;
enabling the user controls associated with a single player terminal to access a plurality of selectable games;
awaiting a user instruction from the single player terminal that selects at least one networked gaming module;
generating a result that determines whether a prize is awarded for each selectable game; and
displaying the result of each selectable game controlled by the associated player terminal on a publicly viewable display that is operatively coupled to the selected networked gaming module.

2. The gaming method of claim 1, wherein awaiting the user instruction, further comprises receiving the user instruction that accesses a plurality of selectable games from the single player terminal.

3. The gaming method of claim 2 further comprising enabling a progressive server to be communicatively coupled to the plurality of gaming modules, the progressive server operatively coupled to a progressive display that is publicly viewable.

4. The gaming method of claim 3 further comprising identifying a total quantity of gaming modules, and enabling the single player terminal to be associated with up to one half of the total quantity of gaming modules.

5. The gaming method of claim 1 further comprising enabling a plurality of player terminals to access the plurality of gaming modules such that each player terminal is associated with a single selectable game.

6. The gaming method of claim 5 further comprising enabling a progressive server to be communicatively coupled to the plurality of gaming modules.

7. A gaming system that enables a player terminal to access a plurality of selectable games, the gaming system comprising:
a plurality of networked gaming modules, wherein each networked gaming module is configured to control a selectable game;
a plurality of player terminals, wherein each player terminal includes a plurality of user controls and each player terminal is communicatively coupled to each networked gaming module;
a single player terminal having an associated plurality of user controls that are configured to access a plurality of selectable games;
a user instruction that is received from the single player terminal that selects at least one networked gaming module;
a result that determines whether a prize is awarded for each selectable game; and
a publicly viewable display operatively coupled to the selected networked gaming module, wherein the publicly viewable display shows the results of each selectable game controlled by the associated player terminal.

8. The gaming system of claim 7 wherein the single player terminal accesses a plurality of selectable games, wherein each selectable game is configured to operate on a separate gaming module.

9. The gaming system of claim 8 further comprising a progressive server that is communicatively coupled to the plurality of gaming modules, the progressive server being operatively coupled to a progressive display that is publicly viewable.

10. The gaming system of claim 9 further comprising a total quantity of gaming modules that are identified and enabling the single player terminal to associate up to one half of the total quantity of gaming modules with the single player terminal.

11. The gaming system of claim 7 further comprising a plurality of player terminals that access the plurality of gaming modules such that each player terminal is associated with a single selectable game.

12. The gaming system of claim 11 further comprising a progressive server that is communicatively coupled to the plurality of gaming modules, the progressive server being operatively coupled to a progressive display that is publicly viewable.

13. The gaming system of claim 12 further comprising a set time period during which each player terminal is associated with the single selectable game.

14. A player terminal configured to access a plurality of selectable games, the player terminal comprising:
the player terminal being configured to be communicatively coupled to each networked gaming module, the player terminal having a plurality of user controls that are configured to access a plurality of selectable games; and
a user instruction that is received by the player terminal that selects at least one networked gaming module, wherein each networked gaming module is configured to control a selectable game and to generate a result that determines whether a prize is awarded for each selectable game, the networked gaming module operatively coupled to a publicly viewable display that shows the results of each selectable game controlled by the player terminal.

15. The player terminal of claim 14 wherein the player terminal accesses a plurality of selectable games, wherein each selectable game is configured to operate on a separate gaming module.

16. The player terminal of claim 15 wherein the networked gaming modules are communicatively coupled to a progressive server that is operatively coupled to a progressive display that is publicly viewable.

17. The player terminal of claim 16 wherein the player terminal associates up to one half of the total quantity of gaming modules with the single player terminal.

18. The player terminal of claim 14 further comprising a plurality of player terminals that access the plurality of gaming modules such that each player terminal is associated with a single selectable game.

19. The player terminal of claim 18 further comprising a progressive server that is communicatively coupled to the plurality of gaming modules, the progressive server being operatively coupled to a progressive display that is publicly viewable.

20. The player terminal of claim 19 further comprising a set time period during which each player terminal is associated with the single selectable game.
